(19) United States
(12) Patent Application Publication
(10) Pub. No.: US 2012/0245994 A1
(43) Pub. Date: Sep. 27, 2012

(54) TRACKING AND REWARDING MAILER RESPONSE

(76) Inventors: Aaron Lovelace, Seattle, WA (US); Steve Markowitz, Honolulu, HI (US)

(21) Appl. No.: 13/427,772

(22) Filed: Mar. 22, 2012

Related U.S. Application Data
(60) Provisional application No. 61/467,343, filed on Mar. 24, 2011.

(51) Int. Cl. G06Q 30/02

(52) U.S. Cl. 705/14.41; 705/14.4

(57) ABSTRACT

Direct mail campaigns for a plurality of vendors are included in a rewards program. The corresponding mailers have a distinctive identifier visible from the outside of the mailer and a unique code inside the mailer that is not visible from the outside of the mailer. Recipients of the mailers submit the corresponding unique codes to a rewards program implementer that tracks recipients' responses to the mailers and rewards the recipients for promoted activities.

### CROSS-REFERENCE TO RELATED APPLICATIONS

This application claims priority to, and the benefit of, U.S. Provisional Application Ser. No. 61/467,343, filed on Mar. 24, 2011, entitled “Tracking and Rewarding Mailer Response,” which is incorporated herein by reference.

### FIELD

Embodiments generally relate to apparatuses, methods, devices, and systems to track and encourage mailer response, and more particularly, to apparatuses, methods, devices, and systems to track responses to mailer that is associated with a rewards program.

### BACKGROUND

Vendors, such as retailers, businesses, or manufacturers, spend a large amount of their advertising budget on mailers, such as paper direct mailers. However, the success of these mailers is hard to track. Recipients may simply throw away the mailer without opening it or the recipient may open the mailer but ignore the content. Currently, it is difficult to measure an opening rate of such a mailer when the recipient does not respond to the content of a mailer in a commercially beneficial way.

Accordingly, it would be an advance in the art of commerce to provide solutions for convenient and efficient tracking of recipient responses to paper mail advertising messages.

### SUMMARY

In certain embodiments, the campaign of the vendor is included in a rewards program for a plurality of vendors. A vendor requests a batch of unique codes for a campaign of the vendor. The batch of unique codes is generated. The batch of the unique codes is sent to a distributor of the mailer along with a distinctive identifier of the rewards program. The distributor is instructed to include the unique code inside the mailer and conspicuously display the distinctive identifier on the mailer such that it is visually perceivable without opening the mailer.

### BRIEF DESCRIPTION OF THE DRAWINGS

The invention will be better understood from a reading of the following detailed description taken in conjunction with the drawings in which like reference designators are used to designate like elements, and in which:

FIG. 1 is a schematic representing a rewards program that includes multiple vendor campaigns;

FIG. 2 illustrates Applicants' mailer response system;

FIG. 3 summarizes methods and/or processes related to information collection and reporting, according to an embodiment; and

FIGS. 4, 5a, and 5b illustrate screen shots of User Interface for rendering on a recipient computing device of FIG. 2.

### DETAILED DESCRIPTION

In certain embodiments, a rewards program rewards recipients of direct mail promotions for opening the direct mail and/or other activities. For example, the rewards program includes goods, services, points, entry into a sweepstake, cash, or gift cards, which the recipient earns through promoted behavior and redeems or transfers to another person as a gift.

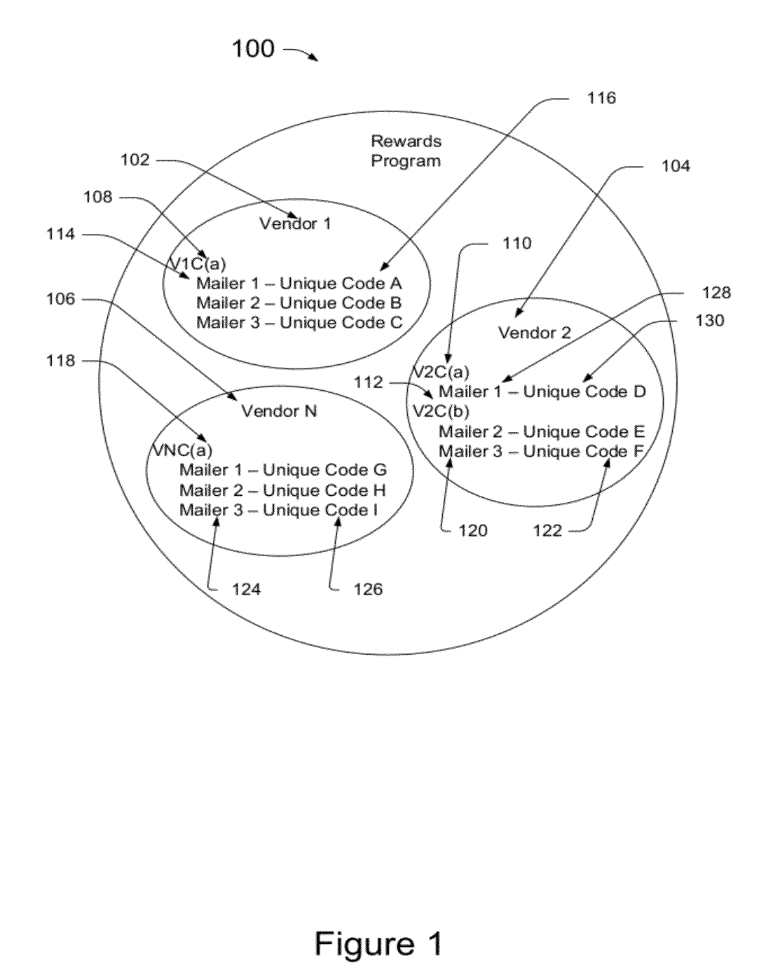

The rewards program includes campaigns for such direct mail promotions of a plurality of vendors that are to be communicated to a recipient via a mailer, such as at least one of a paper mail, an electronic mail (e.g., Short Message Service message, Multimedia Messaging Service message, and/or email), and a mobile application. In FIG. 1, a rewards program 100 includes campaigns of vendor (1) 102, vendor (2) 104, and vendor N 106, where N means there can be any number of vendors. Vendor (1) 102 has campaign V1C(a) 108 in the rewards program 100; vendor (2) 104 has campaigns V2C(a) 110 and V2C(b) 112 in the rewards program 100; and vendor (n) 106 has campaign VNC(a) 118 in the rewards program 100. For example, the V1C(a) 108 of vendor (1) 102 is an advertisement for products of vendor (1) 102 that are on sale; V2C(a) 110 of vendor (2) 104 is an announcement of a new product launch of vendor (2) 104; V2C(b) 112 of vendor (2) 104 is a coupon for a good or service of vendor (2) 104 and/or another vendor, such as vendor (1) 102; and VNC(a) 118 of vendor N 106 is another marketing promotion, each of which is to be sent in a respective mailer to a recipient.

In certain embodiments, the mailers for each campaign in the rewards program 100 are associated with a corresponding unique code. For example, in FIG. 1, V1C(a) Mailer(1) 114 is associated with Unique Code A 116; V2C(a) Mailer(1) 128 is associated with Unique Code D 130, V2C(b) Mailer(3) 120 is associated with Unique Code F 122, VNC(a) Mailer(3) 124 is associated with Unique Code I 126. In certain embodiments, the association occurs through a look up table or by electronically matching information about the mailer with the corresponding unique code in a database, for example.

In certain embodiments, the unique code for each mailer is included inside the mailer. To illustrate, the V2C(b) Mailer (3) 120 is a paper coupon of the vendor (2) 104. Here, the unique code F 122 is imprinted on the paper coupon or a label that is affixed to the paper coupon. Alternatively, or in combination, the unique code I 126 is imprinted on a separate sheet of paper that is included in the mailer along with the coupon. The unique code included inside the mailer is not visible from the outside of the mailer.

In certain embodiments, the unique code is associated with an SMS message that is to be transmitted to a corresponding recipient (e.g., the unique code is stored in a database in association with the text of an SMS message and/or with an electronic address of the recipient, such as a telephone number). In yet another example, the unique code is part of a mobile application. To illustrate, an application that is downloadable by a computing device of the recipient (e.g., smart phone or tablet) includes the unique code. Alternatively, or in combination, an Application Programming Interface (API) that is downloaded onto the computing device of the recipient includes data that allows the API to access the unique code stored on another computing device, such as a server.

In certain embodiments, the unique code is a randomly generated alphanumeric code. For example, an algorithm is executed on a computer to produce a batch of pseudo-random alphanumeric codes. Alternatively, or in combination, in certain embodiments, the unique code is encoded with information. For example, the first five digits of the unique code is the zip code or longitude/latitude coordinate (e.g., “40N50”) of the recipient. In another example, the unique code includes information about the recipient, such as a membership number (e.g. website profile user name or ID) or demographic information about the recipient (e.g., if the first digit is a “1,” then the income range of the recipient is between $US70,000 to $US50,000; if the second digit is a “2,” then the head of the household is a female). In yet another example, the unique code includes information about the vendor (e.g., “5” means its vendor (5), “C3” means it's the vendor's third campaign in the rewards program 100). In yet another example, the unique code includes the date, a duration of the campaign, a campaign identifier, a type of the campaign (e.g., coupons, new product, or advertisement), or other information. In certain embodiments, the unique code is an Internet Uniform Resource Locator (URL). Consequently, in certain embodiments, the unique code includes any or all such encoded information or other encoded information.

In certain embodiments, each unique code is unique within a batch (e.g., each individual unique code is different from other individual unique codes within a batch for a campaign). Alternatively, or in combination, the unique codes are different between campaigns but commonly used within the campaign (e.g., all mailers within one campaign share the same unique code, which is different from the unique code printed on mailers in a different campaign).

A distinctive identifier, unique to the rewards program 100, is consistently used with each mailer in the rewards program 100. The distinctive identifier is conspicuously displayed on the outside of each mailer distinguishing the mailer as one associated with the rewards program 100. In certain embodiments, the distinctive identifier is a color of the envelope of the mailer, a design on the outside of the mailer, a logo imprinted on the envelope or included in an MMS message, a stamp or postmark, or other mark. Here, the recipient of the mailer recognizes the distinctive identifier and associates it with the rewards program 100 in which the recipient will receive a reward for: (a) opening the mailer; (b) responding to inquiries or offers within the mailer; or (c) other promoted behavior within the rewards program 100, for example. Other means for earning rewards include: placing a telephone call to purchase a product or service or to inquire more information; going to the vendor's place of business with the mailer and showing it to an employee or agent of the vendor; ordering or requesting through the mail (such as through a catalog or by inquiry or order card) a product or service advertised in the mailer; filling-in a form on a Website on the Internet; visiting an URL, which has the associated code contained or encoded in it; ordering or inquiring about a product or service through a mobile device such as cellular phone or other Internet-enabled mobile device, for example.

The recipient accesses the received mailer revealing the unique code associated with the mailer, such as by opening a paper mailer which reveals the unique code printed therein. In order to earn or redeem a reward within the rewards program 100, the recipient submits the unique code to a rewards program implementer. For example, the recipient uses a computer to access a User Interface of a website associated with the rewards program implementer. The recipient enters the unique code into a query box of the User Interface and earns a reward for opening the mailer.

In certain embodiments, the Universal Resource Locator (URL) of the rewards program website is the unique code or is pre-populated with the unique code and/or information that identifies the recipient. Here, the rewards program website has multiple URL's that are each tailored to specific unique codes or recipients. For example, a mailer received by one such recipient (“recipient 1234567”) includes the unique code which is URL “http://www.Rewardsprogram.com/redeem?code=campaingwxls_recipient1234567,”such as by including the URL in an SMS message to the recipient 1234567, a hyperlinked text in an email to the recipient 1234567, or a QRCode in a MMS message to the recipient 1234567. The recipient enters the URL unique code into a browser to render a User Interface of a customized rewards program website that indicates the reward earned by the recipient 1234567. Here, the recipient need not enter any other information to earn the reward.

In another embodiment, the rewards program website URL is pre-populated with the unique code. For example, the mailer includes the URL “http://www.Rewardsprog.com/redeem?code=123-unique-code.” Here, the recipient enters the received URL into a browser and renders a User Interface of the rewards program website that has the unique code already entered into a query box. As with the previous embodiment, the recipient earns a reward for opening the mailer without further action.

In certain embodiments, the recipient calls a phone number associated with the rewards program implementer to interact with an automated or manned agent of the rewards program implementer. For example, the recipient verbally or textually relays the unique code. Alternatively or in combination, the recipient scans the unique code using a mobile phone and send it to a computing device associated with the rewards program 100. In certain embodiments, once the unique code is submitted, it is no longer valid for future rewards in the campaign for the recipient.

Sending the unique code to the rewards program implementer is an indication that the recipient accessed (e.g., opened) the mailer because, in certain embodiments, the unique code or specialized URL is visible when the mailer is opened.

In certain embodiments, additional rewards are given to the recipient for responding to the mailer in other ways that benefit the vendor. For example, in certain embodiments, some mailers have more than one unique code, or multiple rewards are given with one unique code. For example, there may be a first unique code for accessing the mailer and a second unique code for making a purchase based on the data in the mailer. To illustrate, the recipient receives a coupon mailer including a unique code. The recipient access a website of the rewards program implementer and enters the first unique code into a query box of a User Interface of the rewards program implementer. The recipient then purchases a product of the vendor using the coupon. The recipient then enters the second unique code at the User Interface, along with a receipt number for the purchase, to earn another reward.

As a second example, there may be a single unique code that is used to receive rewards for two different actions, first for opening a mailer, and second, for taking further action. To illustrate, the recipient receives a survey mailer including a unique code. The recipient visits a URL of a rewards program website of the rewards program implementer. This URL contains the unique code and possibly additional information used to identify the recipient. When the recipient visits the URL indicated on the mailer, the recipient earns a first reward for opening the mailer. At this point, the recipient decides to complete the survey initially mailed in the mailer. After completing the survey, the recipient is rewarded again for completing the survey. Here, no second unique code was generated or needed to receive further reward for completing the survey.

Because the rewards program is across vendors, in certain embodiments, the recipient receives a first mailer from a first vendor (e.g., a clothing store), earn rewards, then receive a second mailer from a second vendor (e.g., a pet store), and earns more rewards.

In certain embodiments, the recipient has a profile associated with the rewards program 100. The recipient creates the profile with the rewards program 100 via a User Interface associated with the website of the rewards program implementer, for example. To illustrate, the recipient uses the computing device of the recipient to log on, via the User Interface, and accesses the profile to determine the amount of rewards earned or redeemed, change the recipient's address, send the earned rewards of the recipient to another person as a gift, and/or other activities. The profile of the recipient and corresponding activity is saved in a data repository of the rewards program 100.

In certain embodiments, a value of subsequent rewards is a function of a previously earned reward. For example, the recipient earns 100 points for the first time the recipient enters a unique code, associated with a first vendor's campaign, into the User Interface of the website of the rewards program implementer. Subsequently, the recipient receives 200 points (e.g., second reward=2×first reward) for entering a second unique code associated with a second vendor.

In certain embodiments, the earned rewards is cumulative. The recipient accumulates points, for example, and select goods/services from a list of goods/services displayed on the rewards program website or in a paper catalog. Alternatively, or in combination, the earned rewards are cumulative goods or services, such as earning a $US250 gift card (an accumulation of a first $US50 gift card and a second $US200 gift card) that is then sent to the residence of the recipient.

In certain embodiments, an open rate of one or more recipients is tracked. For example, a batch of 1000 unique codes is generated for a campaign of vendor (1) 102. After the mailers are sent to recipients, 500 of the unique codes in the batch of 1000 are received at the rewards program website. Consequently, in this example, at least half of the recipients of the mailers associated with the campaign of the vendor (1) 102 opened the mailer. In certain embodiments, the analysis is reported back to the corresponding vendor (1) 102.

In certain embodiments, the open rate for mailers in a campaign is improved when the campaign is part of the rewards program 100. Here, the recipients recognize the distinctive identifier on the mailer. For example, the recipients prioritize opening the mailer because the recipient knows that opening the mailer results in a reward. This increase in frequency in opening the mailer likely increases the success of the campaign because the recipient sees the content of the mailer.

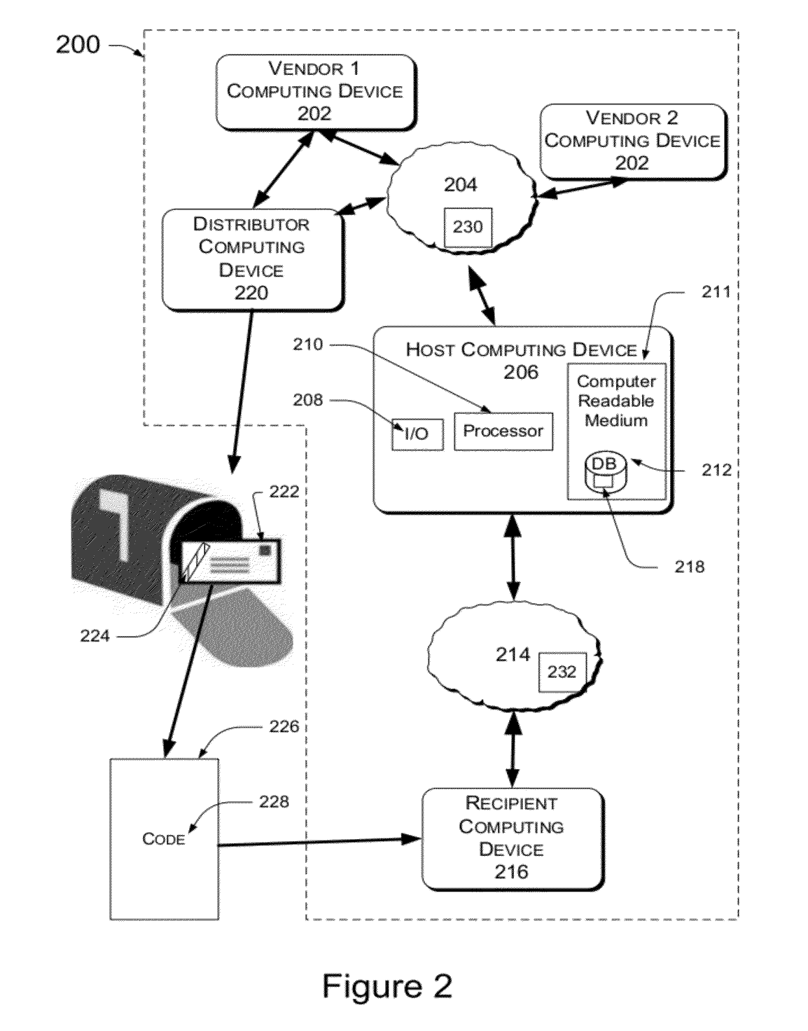

In FIG. 2, a system 200 for tracking mailer response is illustrated. The system 200 depicts a host computing device 206 that is communicatively connected to a recipient computing device 216 through a first communication fabric 214; and to a vendor 1 computing device 202, a vendor 2 computing device 202, and a distributor computing device 220 through a second communication fabric 204. Although one recipient computing device 216, two vendor computing devices 202, and one distributor computing device 220 are shown in FIG. 2, it will be apparent that any number of entities and corresponding devices can be part of the system 200, and further that, while two communication fabrics 204 and 214 are shown, any number of communication fabrics could be provided in the system 200.

In certain embodiments, the vendor computing devices 202, the host computing device 206, the vendor computing devices 202, the distributor computing device 220, and the recipient computing device 216 (collectively “Computing Devices”) are each an article of manufacture. Examples of the article of manufacture include: a server, a mainframe computer, a mobile telephone, a personal digital assistant, a personal computer, a laptop, a set-top box, an MP3 player, an email enabled device, a tablet computer, or a web enabled device having one or more processors (e.g., a Central Processing Unit, a Graphical Processing Unit, or a microprocessor) that is configured to execute an algorithm (e.g., a computer readable program code or software) to receive data, transmit data, store data, or performing methods or other special purpose computer. Each Computing Device includes a non-transitory computer readable medium having a series of instructions, such as computer readable program steps encoded therein. In certain embodiments, the non-transitory computer readable medium includes one or more data repositories. For example, the data repository stores profiles of the recipients, their corresponding responses, their earned and/or redeemed rewards, or information about the vendors such as the vendor's campaign scope, duration, success rate, and the like.

In certain embodiments, the data repository is one or more hard disk drives, tape cartridge libraries, optical disks, or any suitable volatile or nonvolatile storage medium, storing one or more databases, or the components thereof, in a single location or in multiple locations, or as an array such as a Direct Access Storage Device (DASD), redundant array of independent disks (RAID), virtualization device, and the like. In certain embodiments, the data repository is structured by a database model, such as a relational model or a hierarchical model. In certain embodiments, the data repository has a non-relational model and/or cloud database model.

In certain embodiments, the Computing Devices include wired and wireless communication devices which can employ various communication protocols including near field (e.g., “Blue Tooth”) and/or far field communication capabilities (e.g., satellite communication or communication to cell sites of a cellular network) that support any number of services such as: Short Message Service (SMS) for text messaging, Multimedia Messaging Service (MMS) for transfer of photographs and videos, or electronic mail (email) access.

The communication fabrics 204 and 214 comprise one or more switches 230 and 232, respectively. In certain embodiments, the communication fabrics 204 comprises the Internet, an intranet, an extranet, a storage area network (SAN), a wide area network (WAN), a local area network (LAN), a virtual private network, a satellite communications network an interactive television network, or any combination of the foregoing. The communication fabrics 204 and 214 contain either or both wired or wireless connections for the transmission of signals including electrical connections, magnetic connections, or a combination thereof. Examples of these types of connections include: radio frequency connections, optical connections, telephone links, a Digital Subscriber Line, or a cable link. In certain embodiments, communication fabrics 204 and 214 utilizes any of a variety of communication protocols, such as Transmission Control Protocol/Internet Protocol (TCP/IP), for example.

By way of example, the host computing device 206 is shown including a processor 210, a non-transitory computer readable medium 211, an input/output means 208 (e.g., a keyboard, a mouse, a stylus and touch screen, or a printer) and a data repository DB 212. The processor 210 accesses executable code stored on the non-transitory computer readable medium 211, and executes one or more instructions 218 to, for example, electronically communicate with the recipient computing device 216 or the vendor computing devices 202.

One or more portions of the system 200 can be implemented as a web-based software application. Although not shown, in some embodiments, at least one or more portions of the system 200 can be implemented as a software and/or hardware module that can be locally executed on one or more of the Computing Devices. In such instances, other functionality of the system 200 can be accessed via the communication fabrics 204 and 214. For example, a software application locally installed at the recipient computing device 216 can be used to access at least a portion of the system 200.

In certain embodiments, one or more portions of the 200 includes a hardware-based module (e.g., a digital signal processor (DSP), a field programmable gate array (FPGA)) and/or a software-based module (e.g., a module of computer code, a set of processor-readable instructions that can be executed at a processor). In some embodiments, one or more of the functions associated with, for example, the system 200 is performed by different modules and/or combined into one or more modules.

In certain embodiments, a recipient receives a mailer 222 that has the distinctive identifier 224, shown in FIG. 2 as a stripe across the outside of the envelope of the mailer 222. A document inside 226 the mailer 222, such as an advertisement that is part of a campaign of vendor (1), includes the unique code 228, which is unique to the recipient and to the vendor (1). The recipient uses the recipient computing device 216 to transmit the unique code 228 to the host computing device 206 via the communication fabric 214.

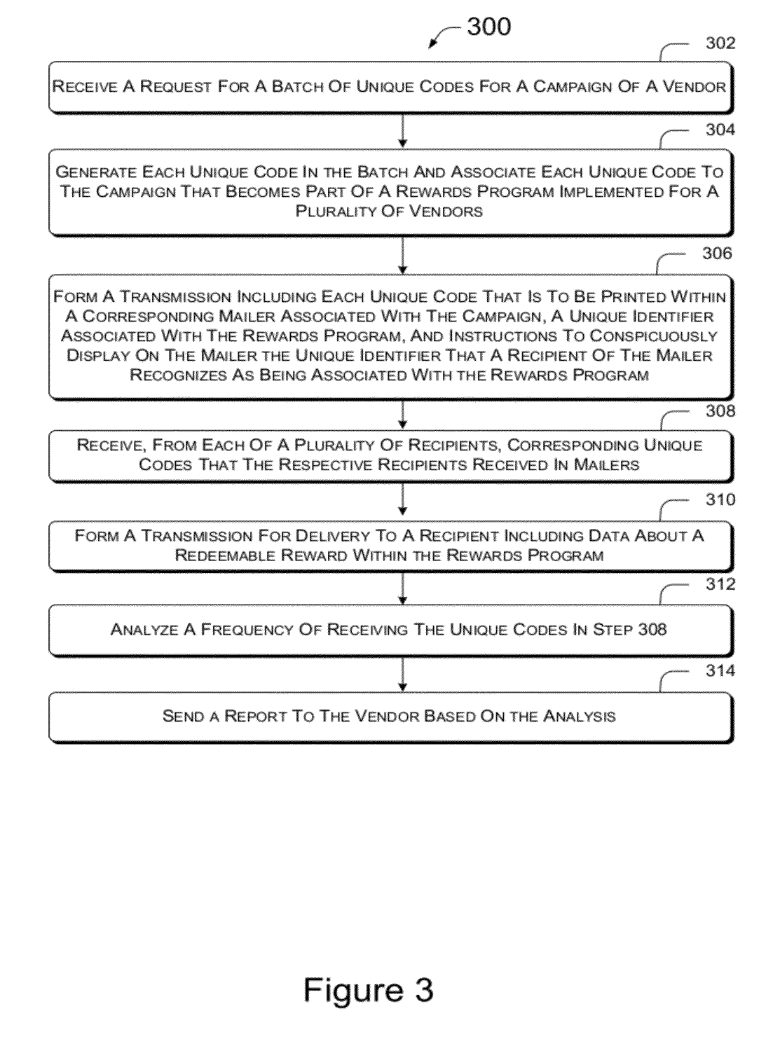

Referring to FIG. 3, a flow chart summarizes an exemplary method for tracking recipient responses to mailers. At step 302, a request for a batch of unique codes for a campaign of a vendor is received. At step 304, each unique code in the batch is optionally generated and associated with the campaign of the vendor. For example, the batch of unique codes are included in a look up table that links the batch with the vendor. In another example, the association occurs by matching the batch with the vendor in a relational database. The campaign is included as part of the rewards program for a plurality of campaigns of a plurality of corresponding vendors. At step 306, a transmission is formed for delivery to the distributor computing device 220 of a distributor that prints the mailers and sends them to recipients. The transmission includes the batch of unique codes, at least one of which is included in the corresponding mailer; a distinctive identifier associated with the rewards program; and instructions to conspicuously display the distinctive identifier on the mailer.

In certain embodiments, the distributor computing device 220 is the same as the vendor 1 computing device 202. To illustrate, vendor 1 computing device 202 request a batch of unique codes. The host computing device 206 generates the batch and responds to the request with the generated batch of unique codes. Vendor 1 then prints and mails the mailers with the distinctive identifier on the outside of the mailer and a corresponding unique code inside each mailer. Alternatively, or in combination, the vendor 1 computing device 202 then instructs the distributor to print and mail the mailers.

In certain embodiments, the mailer is delivered to the recipient via a postal service. Alternatively, or in combination, a non-postal delivery service is used to deliver the mailer, such as via a currier, or a delivery service for a third-party (e.g., fast food delivery service or grocery delivery service). In certain embodiments, the mailer is transmitted to the recipient computing device 216, such as sending the mailer as an SMS to a cellular phone of the recipient.

The recipient, in turn, receives the mailer and recognizes the distinctive identifier as one associated with the rewards program 100. Motivated by the potential of earning rewards, the recipient opens the mailer to reveal a unique code therein.

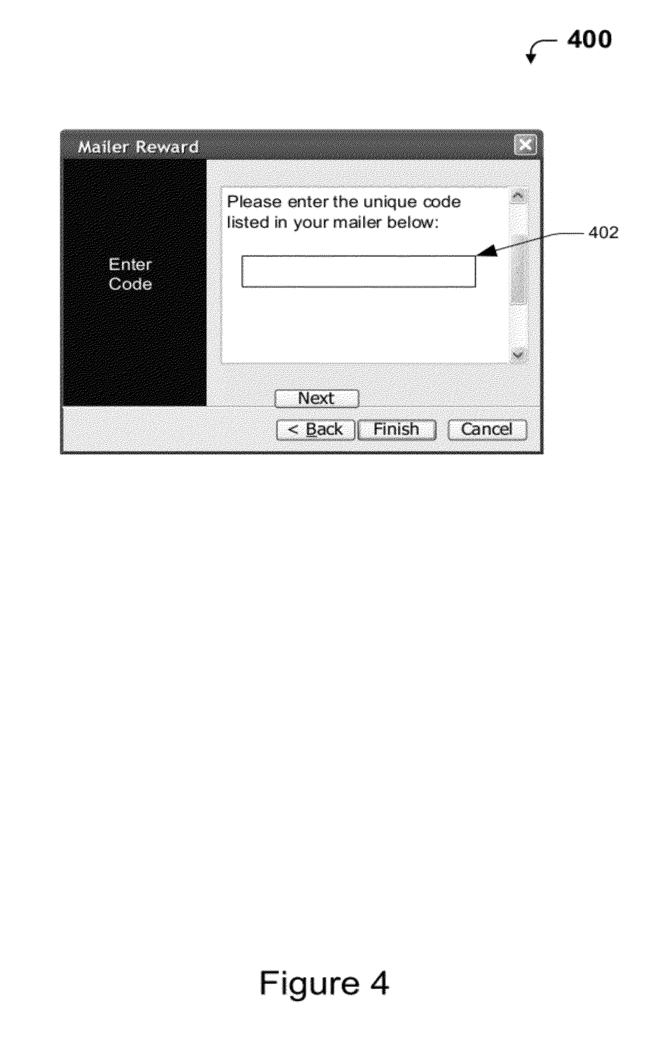

Referring back to FIGS. 1, 3, and 4, at step 308, the recipient submits the unique code in order to earn a reward. For example, the recipient uses a recipient computing device 216 to access the host computing device 206. For example, the recipient opens a web browser that displays a User Interface, such as User Interface 400 of FIG. 4. The recipient then enters the unique code inside the mailer into a query box 402 of FIG. 4. In other implementations, the mailer emits a radio frequency signal, or has a bar code or other data that can be scanned or otherwise received by the recipient computing device 216 and uploaded to the host computing device 206.

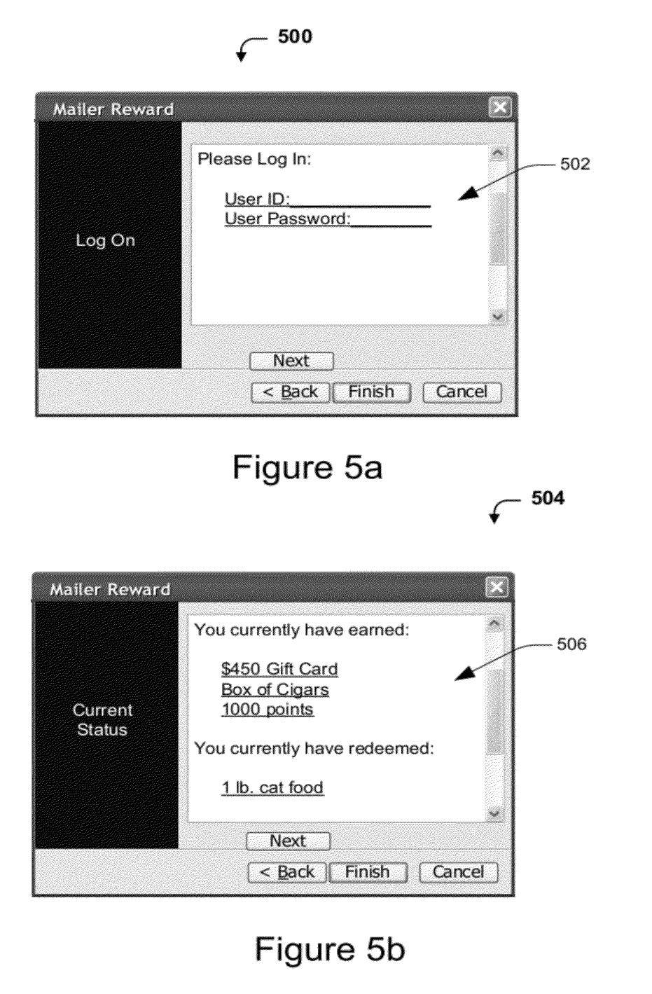

At step 310 of FIG. 3, a transmission is formed for delivery to the recipient that entered a corresponding unique code. The transmission includes data about an earned reward within the rewards program 100. In certain embodiments, the recipient has a profile stored within a data repository 212 along with data about the recipients past activity. To illustrate, a recipient uses the recipient computing device 216 to render the User Interface 500 of FIG. 5. Here, the recipient logs on to access the host computing device 206, using a user identifier 502 and optionally a password. The recipient then checks the status of earned and redeemed rewards 506.

Referring back to FIG. 3, at step 312, a frequency of receiving the unique codes in the batch is analyzed. For example, the open rate is calculated as previously described. Alternatively, or in combination, the information encoded in the received unique codes is tracked. For example, the open rate for a particular geographic location is analyzed. To illustrate, a campaign of a vendor has two geographic regions “A” and “B” for its recipients. Five hundred of the unique codes in the corresponding batch of alphanumeric unique codes start with “A” as the initial alphanumeric while the remaining 500 unique codes start with “B” as the initial alphanumeric, for the respective regions. After the mailers are disseminated, only 30% of the A unique codes are entered at the rewards program website while 70% of the B unique codes are received at the rewards program website. An analysis of this data indicates that the B region had a better open rate than the A region. Alternatively, or in combination, the analysis compares means of receiving the unique codes from the recipients. To illustrate, in the above example, 5% called a phone number to submit the unique code while 95% entered their unique codes into a query box rendered via a User Interface.

At step 314, a report is sent to the vendor based on the analysis. In the above example regarding region A versus region B, the report indicates that the A region had a 30% open rate and was not as successful as the “B” region that had 70% open rate. In reliance on the report, the vendor determines that the A region may not be a good investment and changes the strategy of the vendor for the next campaign.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” “in certain embodiments,” and similar language throughout this specification may, but do not necessarily, all refer to the same embodiment. It is noted that, as used in this description, the singular forms “a,” “an” and “the” include plural referents unless the context clearly dictates otherwise.

The described features, structures, or characteristics of the invention may be combined in any suitable manner in one or more embodiments. In the above description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included are generally set forth as a logical flow-chart diagram (e.g., FIG. 3). As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method (e.g., FIG. 3). Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

In certain embodiments, individual steps recited in FIG. 3 may be combined, eliminated, or reordered. The computer readable program code described may reside in any other computer program product, where that computer readable program code is executed by a computer external to, or internal to, system 200 (FIG. 2), to perform one or more of steps recited in FIG. 3. In either case, the computer readable program code may be encoded in a non-transitory computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, compactflash, smartmedia, and the like.

Examples of computer readable program code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described. For example, multiple, distributed qualification processing systems can be configured to operate in parallel.

Although the present invention has been described in detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

We claim:

1. An article of manufacture comprising a processor and a non-transitory computer readable medium having computer readable program code disposed therein to facilitate implementation of a rewards program, the computer readable program code comprising a series of computer readable program steps to effect:
receiving a request for a first batch of unique codes for a first campaign of a first vendor;
associating the first campaign with a rewards program implemented for a plurality of said vendors;
associating each said unique code with the first campaign;
and
forming a transmission, for delivery to a distributor computing device, including:
each said unique code that is to be printed within a corresponding mailer associated with the first campaign;
a distinctive identifier associated with the rewards program; and
instructions to conspicuously display on the mailer the distinctive identifier that is recognizable as being associated with the rewards program by a recipient of a corresponding said mailer.

2. The article of manufacture of claim 1, the computer readable program code further comprising a series of computer readable program steps to further effect:
receiving, from a recipient computing device, one said unique code that one said recipient received in a respective said mailer; and
analyzing an open rate based on the received one said unique code.

3. The article of manufacture of claim 2, the computer readable program code further comprising a series of computer readable program steps to further effect forming a second transmission, for delivery to at least one said recipient computing device, data about a redeemable reward within the rewards program.

4. The article of manufacture of claim 3, wherein the data includes reward redemption information about at least one of:
a cash redemption;
a points redemption;
a goods redemption;
a sweepstakes entry redemption;
a services redemption; and
a transferable gift redemption.

5. The article of manufacture of claim 2, wherein the one said recipient computing device is selected from the group consisting of:
a personal digital assistant;
a laptop computer;
a desktop computer;
a tablet computer;
a mobile phone;
a server;
an MP3 player;
a set-top box; and
a combination thereof

6. The article of manufacture of claim 1, the computer readable program code further comprising a series of computer readable program steps to further effect repeating, for a second said vendor:
receiving a request for a second batch of unique codes for a second campaign of the second said vendor;
associating the second campaign with the rewards program;
associating each said unique code in the second batch with the second campaign; and
associating the second campaign with the rewards program, wherein:
the second said vendor is unaffiliated with the first vendor; and
the unique codes in the first batch are different from the unique codes in the second batch;
and
at least one said recipient receives:
a corresponding said mailer associated with the first campaign;
and
a corresponding said mailer associated with the second campaign.
